(19) United States
(12) Patent Application Publication
(10) Pub. No.: US 2017/0307067 A1
(43) Pub. Date: Oct. 26, 2017

(54) COUPLING DEVICE FOR A GEARSHIFT LEVER, GEARSHIFT LEVER DEVICE, AND METHOD FOR PRODUCING A COUPLING DEVICE

(71) Applicant: ZF Friedrichshafen AG, Friedrichshafen (DE)

(72) Inventor: Alex Hessel, Lemforde (DE)

(73) Assignee: ZF Friedrichshafen AG, Friedrichshafen (DE)

(21) Appl. No.: 15/526,264

(22) PCT Filed: Oct. 12, 2015
(86) PCT No.: PCT/EP2015/073498

§ 371 Date: May 11, 2017

(30) Foreign Application Priority Data
Nov. 12, 2014 (DE) 10 2014 223 046.2

(51) Int. Cl. F16H 59/04; F16H 59/02

(52) U.S. Cl. CPC F16H 59/042; F16H 59/0278; F16H 2059/0269; F16H 2059/026

(57) ABSTRACT

A coupling device for a shift lever of a motor vehicle shift lever device includes a moving sliding element having a receiver for accommodating a section of a shift lever and a guide for guiding a two-dimensional movement of the sliding element. The guide has at least one guide element with which the sliding element is engaged. The coupling device is distinguished in that the sliding element can move along two different movement axes (A, B) to the at least one guide element when engaged.

### BACKGROUND

### 1. Field of the Invention

The present invention relates to a coupling device for a shift lever, a shift lever device of a motor vehicle, a motor vehicle shift lever device, and a method for producing a coupling device.

### 2. Background Information

Shift lever devices are used in motor vehicles in at least two ways. By way of example, the shift lever device can form a gear selection device, which has a shift lever designed as a gear selector lever, which can be moved between various positions, wherein each selectable position is dedicated to a gear setting of a gear changing transmission coupled to the gear selection device. When a gear setting is selected by moving the selector lever into the dedicated selector lever position, a gear corresponding to the selected gear setting is engaged in the gear changing transmission via mechanical or electronic connection existing between the selector lever device and the gear changing transmission. Furthermore, a shift lever device can be used in a motor vehicle in the manner of a steering column switch. The shift lever device has a shift lever designed as a steering column switch thereby, which can be moved to different positions, wherein each shift lever position is dedicated to a predetermined function. By way of example, these functions can be a selection of a gear setting of a gear changing transmission, the operation of a windshield wiper system, or a light system, in particular to select a blinker and/or a high beam, or suchlike.

Common to the shift levers described by way of example, is that the respective shift lever can be moved in at least two parallel shifting tracks, which are connected to one another by a connecting track. The respective shift lever can be coupled to a coupling device thereby, which couples the shift lever to a position detection device, for example, in order to determine the position of the shift lever.

DE 102 31 015 A1 and DE 698 14 095 T2 each disclose such a coupling device for a motor vehicle shift lever. The coupling device couples the motor vehicle shift lever to a position detection device, by means of which predetermined shift lever positions are detected, and a position signal corresponding to the respective detected position is issued.

### SUMMARY

Based on this, the present invention creates an improved coupling device for a shift lever, an improved shift lever device and an improved method for producing a coupling device. Advantageous designs can be derived from the dependent Claims and the following description.

A coupling device for a motor vehicle shift lever can be implemented according to embodiments of the present invention, in particular, which has a simple construction, with a low number of parts, and thus has a shorter tolerance chain, and is cost-efficient.

The proposed coupling device comprises a moving sliding element having a receiver for accommodating a section of a shift lever. The shift lever can be a shift lever of a motor vehicle shift lever device, for example. In particular, the shift lever can be a selector lever for selecting gear settings of a gear changing transmission of a motor vehicle. The gear settings can be gear selections for a forward driving mode and/or a reverse driving mode, and/or a parking lock mode of the motor vehicle, in which a parking lock is activated in the gear changing transmission.

The sliding element can be, in general, a component that can be moved in relation to another component coupled thereto, or functioning therewith. The sliding element is distinguished in that can be moved together with, or forced to move with, the shift lever by means of a coupling with the shift lever, by transference of a movement force acting on the shift lever. The coupling takes place thereby, by means of a receiver, which can accommodate a section of the shift lever for a collective movement of the shift lever and the sliding element. In a state in which the section of the shift lever is accommodated, the sliding element can thus be guided or moved together with the shift lever when the shift lever is actuated. The section of the shift lever can be a central section, which is disposed between two free ends of the shift lever. Alternatively, the section can be a free end of the shift lever. There is therefore no need for other devices or components for initiating a movement of the sliding element. Optionally, at least one device or component can be provided, however, which is coupled to the sliding element in order to apply a movement force to the sliding element, to move the sliding element, e.g. in order to enable a resetting of the shift lever via a movement force acting on the sliding element.

The coupling device furthermore comprises a guide for guiding a two-dimensional movement of the sliding element. A movement is two-dimensional, in particular, when the sliding element can be moved along a first movement axis and along a second movement axis, wherein the first and second movement axes run in different directions. The first and second movement axes have at least one point of intersection, in particular. By way of example, the first and second movement axes form a plane, thus a two-dimensional, Cartesian coordinate system, wherein the first and second movement axes define the respective directional axes of the coordinate system. The sliding element can thus be moved in the plane formed thereby. The guide preferably forms a stationary device or component thereby, with respect to the sliding element. In other words, the guide, in contrast to the sliding element, is disposed such that it cannot move. The guide has at least one guide element, with which the sliding element engages. The at least one guide element is preferably a component that is designed to be able to engage with the sliding element in a form and/or force fitting connection, wherein the form and/or force fitting connection that can be engaged in allows for a relative movement between the guide or the at least one guide element, and the sliding element, based on a movement of the sliding element.

The coupling device according to the present invention is distinguished in that the sliding element can be moved along two different movement axes in relation to the at least guide element when the sliding element is engaged with the guide element. In particular, the sliding element has a counter-engagement element, which is engaged with the at least one guide element. The guide element forms an engagement element, accordingly. The counter-engagement element of the sliding element can thus move along the two different movement axes in relation to the at least one guide element when it is engaged. It is particularly preferred that the at least one guide element can form a component of a tongue-and-groove connection, comprising either a tongue or a groove. A tongue-and-groove connection is distinguished in that the groove and the tongue overlap in at least one cross section of the tongue-and-groove connection, or, alternatively, in an entire cross sectional region of the tongue-and-groove connection. The groove preferably forms a receiving space in its cross section, into which a free end of the tongue extends. By way of example, the cross section of the groove can be designed in the shape of an L, C, U, V, or W, or in a similar shape. It is furthermore preferred that the at least one guide element forms at least the groove of the tongue-and-groove connection, while the sliding element exhibits or forms at least the tongue, which can engage, or engages, in the groove. As a result, the sliding element can be slender or thin with respect to its material thickness, over its entire cross section. Alternatively, it is preferred that the guide element and the sliding element each form at least one tongue-and-groove section comprised of at least one groove and one adjacent tongue, wherein the tongue of the sliding element is designed to engage in the dedicated groove of the guide element, and wherein the tongue of the guide element is designed to engage in the dedicated groove of the sliding element. Such a tongue-and-groove connection can be realized, for example, in that the at least one respective tongue-and-groove section of the sliding element and the guide element has an L, C, U, V, W, or similar shaped cross section design. As a result, a reliable guidance of the sliding element is provided.

A two-dimensional motion of the sliding element can be implemented, in particular, in that the engagement existing between the at least two components, thus the guide element and the sliding element, or between the at least two elements, thus the engagement element and the counter-engagement element, forms a spacing between the at least two components or elements along each of the two movement axes in at least one position of the sliding element, which can be reduced or increased by means of the relative movement of these parts in relation to one another. Such a position can define an end position for the sliding element, for example, in which the elements or components exhibit a predefined spacing along one of the two movement axes in the engaged state, which can be reduced by a movement of the sliding element out of the end position along one of the two movement axes. The reduction can take place, in particular up to an opposite position of the corresponding elements or components. Alternatively or additionally, the position can define an end position for the sliding element, in which the corresponding components or elements are located in the engaged state along one of the two movement axes, disposed opposite one another, wherein an increasingly larger spacing can be formed between the two components or elements, due to the movement of the sliding element along one of the two movement axes, away from the end position, while maintaining the engaged state. Furthermore, such a position can define a central position of the sliding element along at least one of the two movement axes, in which the corresponding components or elements exhibit a predefined spacing to one another along one of the two movement axes, when in the engaged state, which can be reduced by means of a movement in a first direction, and can be increased by means of a movement in a second direction, opposite the first direction, when the sliding element is moved along one of the two movement axes, out of the central position. It is furthermore preferred that the position defines a central position for the sliding element along the two movement axes in the manner described above.

The two differing movement axes thus define a movement plane for the movements of the sliding element, wherein the movement plane is planar according to a preferred embodiment, i.e. it is not curved. A planar movement plane is ideal, in particular, for a detection of a position of the shift lever that can be executed with the coupling device. By way of example, the sliding element of the coupling device can have at least one signal issuing element, the signals from which can be received by a signal receiver, wherein the at least one signal issuing element and the dedicated signal receiver can form components of a position detection device for determining a position of the shift lever. A detection of the shift lever position can thus be implemented in a structurally simple manner.

The two differing movement axes preferably extend orthogonally to one another. The first and second movement axes thus form a planar, two-dimensional Cartesian coordinate system, which defines a movement plane for the sliding element. As a result, disruptive effects, e.g. in a position detection device coupled to the coupling device through possible signal overlapping or signal duplication, can be substantially minimized.

According to a preferred embodiment, the guide has a further guide element, with which the sliding element is engaged, wherein the guide element and the further guide element are disposed opposite one another, with the sliding element disposed therebetween. It is further preferred that the sliding element comprises a further counter-engagement element, in addition to the one counter-engagement element for engaging with the at least one guide element, which is designed to engage with the further guide element. The guide element and the further guide element are disposed such that they lie opposite one another, with the counter-engagement element and the further counter-engagement element disposed therebetween. As a result, a reliable guidance for the movements of the sliding element can be ensured. It is further preferred that the guide element and the further guide element each have opposing stops, which are disposed along one of the two movement axes in order to limit the movement of the sliding element along this movement axis. As a result, an extent of the movement of the sliding element along the corresponding movement axis can be limited in a structurally simple manner. Thus, in conjunction with the shift lever, a stop can also be provided for a shift lever movement.

According to a preferred embodiment, the receiver has an anti-twist element for engaging with a anti-twist counter-element of the shift lever. The anti-twist element is preferably formed by an opening or cavity formed in the shift lever in the region of the receiver. The opening or cavity has at least one opening facing the center of the receiver, via which the anti-twist counter-element can engage in the opening or cavity. By way of example, the anti-twist counter-element can be a resiliently supported pin, which can be moved in a resilient manner back and forth along a movement axis at an angle to a longitudinal extension axis of the shift lever, by means of which the pin can be placed in or removed from a position in the cavity lying opposite the opening.

It is further preferred that the movement axis of the anti-twist counter-element extends orthogonally to the longitudinal extension axis of the shift lever. The anti-twist counter-element with its resilient bearing is preferably designed thereby, such that the anti-twist counter-element can deviate, when the section of the shift lever having the anti-twist counter-element is inserted in the receiver of the sliding element, away from the edges delimiting at least one opening in the opening or cavity, and subsequently engage in the opening or cavity, due to its resilient bearing. The edges limiting the at least one opening can be an edge of the receiver of the sliding element.

It is furthermore preferred that the at least one opening of the opening or cavity extends to a surface of the sliding element, which faces in a direction running parallel to the longitudinal extension axis of the shift lever or parallel to a receiving axis, along which the section of the shift lever can be inserted in the receiver of the sliding element. The opening or cavity forms a shaft in the sliding element in this manner, which extends from the surface side along the receiver axis up to at least a predefined depth of the sliding element. Such a design of the opening or cavity is advantageous, in particular, for an anti-twist counter-element, which extends in the manner of a projection form the section of the shift lever that is to be received. By way of example, the anti-twist counter-element can form a pin, which projects outward from the shift lever. The pin can furthermore preferably be formed as an integral part of the fundamental body forming the shift lever. Sizes of the opening or cavity and of the anti-twist counter-element are adapted to one another such that the anti-twist counter-element can engage in the opening or cavity.

Alternatively, the anti-twist element can form a pin or projection in the manner described above, wherein the anti-twist counter-element forms an opening or cavity formed in the section of the shift lever that is to be received.

An unintended twisting of the sliding element about the longitudinal extension axis of the shift lever in a state in which the section of the shift lever is accommodated can be reliably avoided by means of the engagement of the anti-twist element with the anti-twist counter-element. As a result, a possible tilting of the sliding element in the guide when the shift lever is in the accommodated state, which could prevent an intended movement of the shift lever, can be prevented.

It is furthermore preferred that the depth of the opening or cavity in the sliding element is selected such that the pin can freely, i.e. without obstruction, rotate about at least one pivotal axis of the shift lever into the shaft-like opening or cavity, when the sliding element is installed in the shift lever. By way of example, the anti-twist element can form a passage, which extends parallel to the receiver, thus passing through the sliding element. It is furthermore preferred that the pin can rotate freely about at least two orthogonal pivotal axes of a cardanic-supported shift lever. It is furthermore preferred that the pin has a circular cross section. As a result, possible twisting of the sliding element engaged with the guide, about corresponding axes running orthogonal to the longitudinal extension axis of the shift lever, are minimized.

According to another aspect of the present invention, a shift lever device for a motor vehicle is proposed, wherein the shift lever device comprises a shift lever supported such that it can move at least two-dimensionally. The shift lever can be supported such that it can move two-dimensionally thereby in the known manner, e.g. by means of a typical ball-joint bearing or Cardanic bearing. Furthermore, the shift lever device comprises a coupling device according to one of the embodiments described above. A section of the shift lever is accommodated by the receiver of the sliding element thereby, wherein the receiver is designed to transfer a movement force directed along the respective movement axis between the shift lever and sliding element. As a result, it is ensured that the sliding element can be moved together with, or forced to move with, the shift lever, when the shift lever is moved. This is advantageous in particular for a resetting of the shift lever, which may be provided, for example, in order to move the shift lever back into a shift lever position dedicated to a corresponding, actually engaged, gear setting in the gear changing transmission, or to move it from a selected shift lever position back into a different shift lever position, in particular an initial position of the shift lever, in particular automatically. Such a resetting can take place, for example, by means of an actuator device or a spring device, which can be or is coupled to the sliding element.

According to a preferred embodiment, the shift lever device has a housing, which forms the guide for the shift lever device. By way of example, the housing can have a two-piece design, wherein at least one housing part forms a guide element for the guide. The at least one guide element can preferably form a groove or a tongue of a tongue-and-groove connection, as described above, for example. On one hand, the coupling device can be designed in a simple manner, and on the other hand, the shift lever device can be assembled with an integrated coupling device in a few installation steps.

According to a preferred embodiment, the shift lever has an anti-twist counter-element, which is engaged with an anti-twist element of the sliding element, wherein the anti-twist counter-element and the anti-twist element are formed by at least one pin and one pin receiver that accommodates the pin to prevent a twisting of the sliding element about the shift lever, in particular about a longitudinal extension axis of the shift lever. The anti-twist element as well as the anti-twist counter-element can furthermore preferably have one of the embodiments described above. As a result, the advantages described above can likewise be obtained.

Furthermore, it is preferred that the pin receiver in the sliding element forms a shaft extending in the receiving direction of the pin, which forms a passage through the sliding element, or which has a shaft base, which is at a spacing to the pin in each of the positions triggering a predetermined function; in other words, it does not come in contact therewith. Such a function triggering position can be a position, for example, after assuming which, a selection of a gear setting dedicated to this position takes place, and is conveyed by signaling technology. A minimum spacing formed in each of the positions of the shift lever between the pin and the shaft base thus has a value of greater than zero.

The sliding element preferably has a least one signal issuing element of a position detection device for determining a shift lever position, a latching contour or latching mechanism for latching the shift lever, or a connection for a force transferring element of a parking lock device for engaging and/or disengaging a parking lock of a motor vehicle transmission. As a result, different devices can be coupled to the shift lever device by means of the sliding element or the coupling device, by means of which a function intended by a movement of the shift lever of the shift lever device can be generated. As a result, the shift lever device can have a simple design, and be formed with low number of components.

According to one aspect of the present invention with regard to the method, a method is proposed for producing a coupling device like the one described above, wherein the method comprises a step for providing the sliding element, a step for providing the guide and a step for bringing the sliding element into engagement with the guide. A coupling device like that described above can be created by means of this preferred method with few steps.

Further features and advantages of the invention can be derived from the following description of preferred embodiments of the invention, on the basis of the Figures and drawings, which show details substantial to the invention, and from the Claims. The individual features can each be realized, in and of themselves, or in numerous arbitrary combinations, in a preferred embodiment of the invention.

### BRIEF DESCRIPTION OF THE DRAWINGS

Preferred embodiments of the invention shall be explained below based on the attached drawings. Therein:

FIG. 1 shows a perspective side view of a coupling device according to a preferred exemplary embodiment, in a state in which a shift lever is accommodated;

FIGS. 2 and 3 show different schematic side views of the coupling device with the shift lever shown in FIG. 1;

FIGS. 4 and 5 show respective cross sectional views of the coupling device shown in FIGS. 2 and 3, along the cuts IV-IV and V-V, respectively;

FIG. 6 shows a perspective side view of the coupling device shown in FIG. 1, in a first deflected position of the sliding element;

FIG. 7 shows a perspective side view of the coupling device shown in FIG. 1, in a second deflected position of the sliding element; and

FIG. 8 shows a flow chart for a method for producing a coupling device according to a preferred exemplary embodiment.

### DETAILED DESCRIPTION

In the following description of preferred exemplary embodiments of the present invention, the same or similar reference symbols shall be used for the elements having similar functions shown in the various Figures, wherein there shall be no repetition of the description of these elements.

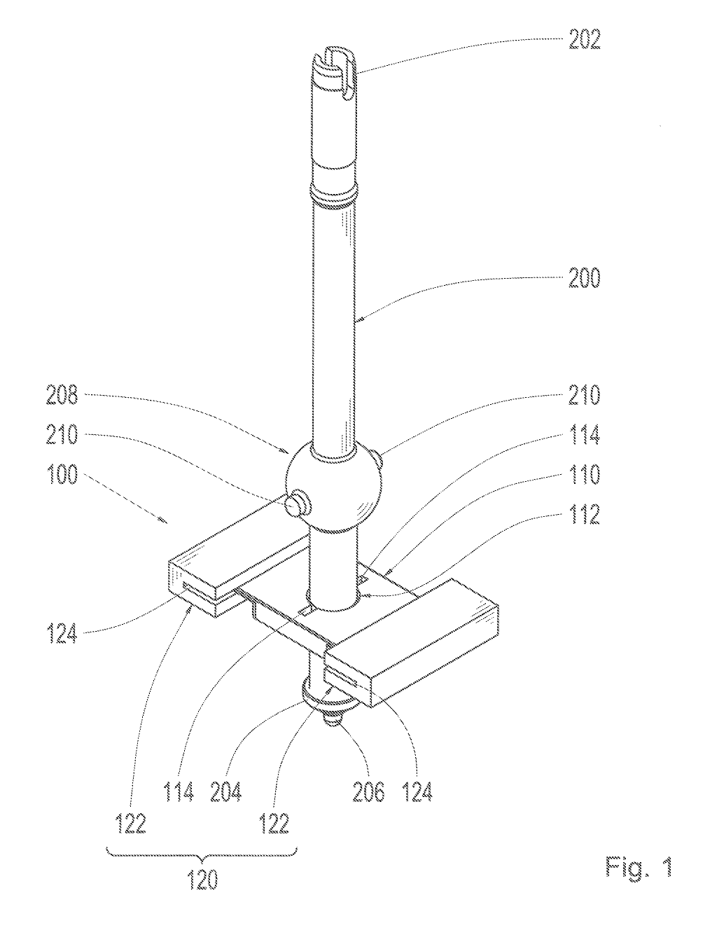

FIG. 1 shows a perspective side view of a coupling device 100 according to a preferred exemplary embodiment in an accommodating state in which a shift lever 200 is accommodated therein. The coupling device 100 comprises a sliding element 110, which is designed in the manner of a plate, wherein opposite ends of the sliding element 110 each engage in a groove 124 of a guide element 122 of a guide 120 of the coupling device 100. The respective ends of the sliding element thus form a tongue of a tongue-and-groove connection. The respective guide elements 122 have a U-shaped cross section, wherein an empty space lying between the legs of the U-shape forms the groove 124. The sliding element 110 is guided by the respective guide elements 122 such that it can move in a direction of extension of the respective groove 124 that defines a plane. The sliding element 110 has a receiver 112 in the middle for accommodating a section of the shift lever 200. The receiver 112 is designed as a passage, wherein the surfaces of the sliding element 110 lying opposite the passage 112 are connected to one another. The receiver 112 has two openings or cavities 114, disposed opposite one another, formed in each case as anti-twist elements, which extend from a surface of the sliding element 110 into the sliding element 110 to predetermined depth, parallel to the passage 112. With this preferred exemplary embodiment, the openings 114 extend through the sliding element 110 and thus form, in each case, a further passage extending parallel to the passage 112.

The shift lever 200 is substantially designed as a rod, wherein a free end 202 of the shift lever 200 forms a connection point for a shift knob, via which the shift lever 200 can be actuated by a user. The further free end 204 lying opposite the free end 202 in the longitudinal extension of the shift lever 200 extends through the sliding element 110 and accommodates a latching pin 206 of a latching device that is not shown. A ball joint 208 having two opposing ball joint pins 210 projecting away from the ball joint 208 is disposed between the free ends 202, 204 of the shift lever 200. The ball joint 208 with the ball joint pins 210 is designed to engage in a ball joint bearing of a housing (not shown) of a shift lever device (not shown) that accommodates the shift lever 200, by means of which the shift lever can be supported such that it can move. The coupling device 100 is disposed thereby on a side of the ball joint 208 facing away from the user, between the ball joint 208 and the latching pin 206. This assembly facilitates an arrangement of the coupling device 100 in the housing of the shift lever device concealed from a user. Furthermore, components of the guide 120, specifically the guide elements 122, can be formed with the housing of the shift lever device. As a result, a number of individual components necessary for the design of the coupling device 100, as well as the shift lever device, can be reduced.

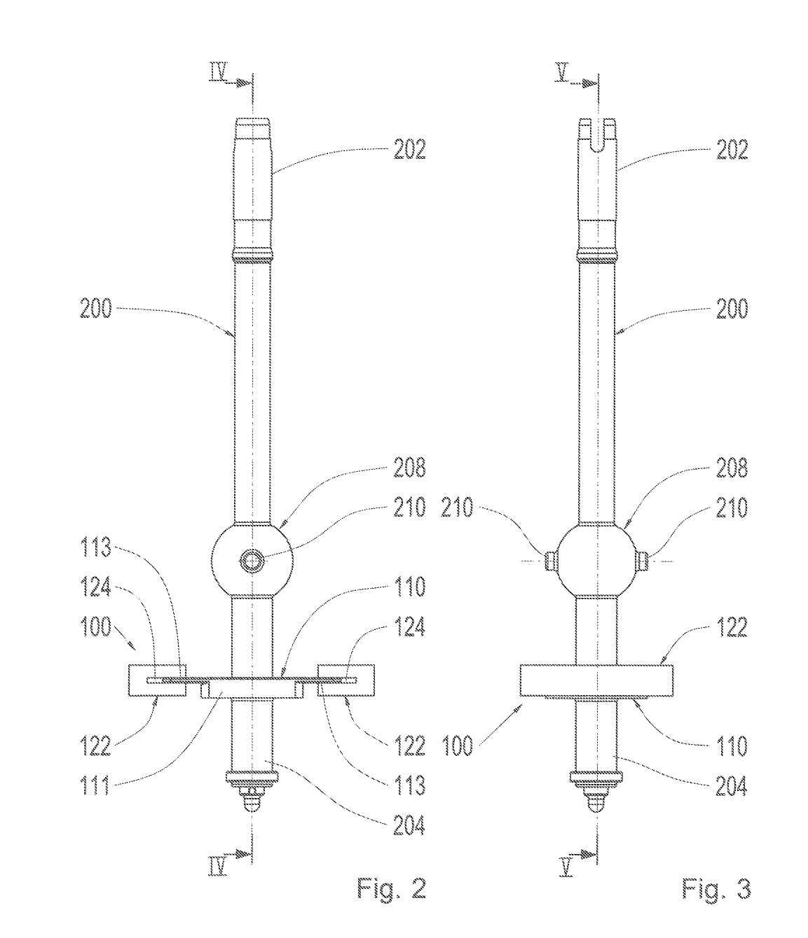

FIG. 2 shows a first side view of the coupling device 100 shown in FIG. 1, in the state in which it accommodates the shift lever 200. Among other things, FIG. 2 shows a lateral outer contour of the sliding element 110. The sliding element 110 has a thick region 111 in a middle section, which comprises the receiver 112 and the anti-twist element 114. Flat ends 113 of the sliding element 110 each extend away from the thick region 111 on opposite sides in opposing directions, each of which forms a tongue that engages in the groove 124. The sliding element 110 is designed such that it is mirror-symmetric in relation to a plane of symmetry passing through a midpoint of the sliding element 110 and running parallel to a receiving axis of the receiver 112. The free ends 113 of the sliding element 110 engage partially in the respective dedicated groove 124 of the respective guide elements 122. In the position shown in FIG. 2, the shift lever 200 as well as the sliding element 110 are located in a middle position. The end surface flat sections of the respective free ends 113 facing away from the sliding element 110 exhibit a predetermined spacing to a floor or base of the cross sectional U-shape of the guide elements 122 forming the respective groove 124 in this middle position. As a result, the sliding element 110 can move toward the respective guide elements 122. The respective base of the U-shape of the respective guide elements 122 forming the groove 124 forms a stop for the movement of the sliding element 110 thereby. In other words, the movement of the sliding element 110 toward the respective guide elements 122 is limited. The sliding element 110 can be moved toward the respective guide elements 122 until the respective free end 113 of the sliding element 110 comes to bear on a wall of the guide element 122 bordering on the groove 124, or strikes this wall, wherein the wall forms the base of the U-shape of the guide element 122. By selecting a size for the groove, or a depth of the groove, respectively, in the respective guide element 122, a movement of the sliding element 110 toward the respective guide elements 122 can be adjusted according to the intended use. When the respective free end 113 of the sliding element 110 bears on the respective guide element 122, the sliding element assumes, in each case, an end position, according to this preferred embodiment. The end position of the sliding element 110 corresponds thereby to an end position of the shift lever 200. In a movement range of the sliding element 110 from the illustrated middle position to one of the respective end positions described above, the respective ends 113 of the sliding element 110 are each at least partially overlapped by the guide elements 122, by means of which a guidance of the sliding element 110 toward the respective guide elements 122 can be implemented. The possible movement of the sliding element 110 toward the respective guide elements 122 forms a first movement axis for the sliding element 110 thereby.

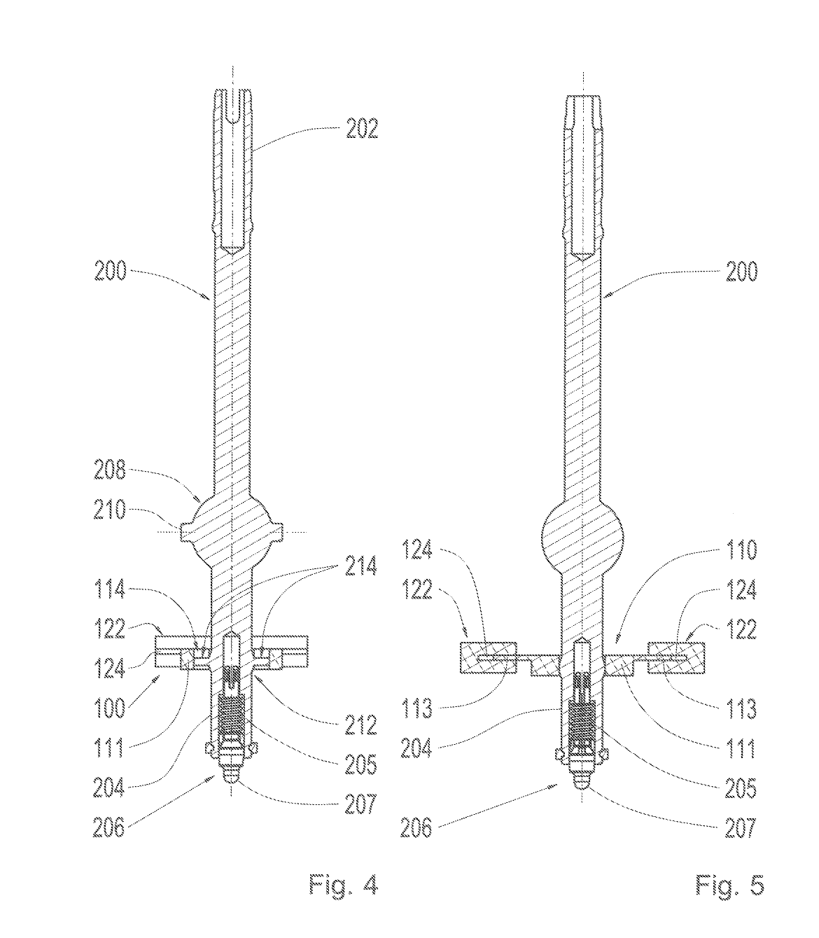

FIG. 3 shows another side view of the coupling device 100 shown in FIG. 1, in the state in which the shift lever 200 is accommodated. FIG. 4 shows a sectional view of the coupling device 100 in conjunction with the shift lever 200 from FIG. 2, along the cut IV-IV. The relative dimensions of the respective guide elements 122 in relation to the sliding element 110 are illustrated by FIGS. 3 and 4. The guide element 122 is broader than the sliding element 110 along the movement axis of the sliding element 122. As a result, a guided movement of the sliding element 110 along a second movement axis that runs orthogonally to the first movement axis described above can be ensured. The first and second movement axes form a movement plane for the sliding element 110 thereby, along which the sliding element 110 can move in relation to the guide 120, or the respective guide elements 122, in a two-dimensional manner.

FIG. 4 also shows an anti-twist assembly formed with the coupling device 100 and the shift lever 200. The thick element 11 of the sliding element 110 receives a securing pin 214, formed as an integral part of the shift lever 200, in the opening 114. The securing pin 214 forms an anti-twist counter-element, which is engaged with the anti-twist element 114, which is formed by the opening 114 formed as a passage. The securing pin 214 extends orthogonally to the longitudinal extension axis of the shift lever 200, and parallel to the second movement axis of the sliding element 110 in the illustrated state. The securing pin 214 extends thereby away from another ball joint 212, which is formed as an integral part of the shift lever 200. The receiver 112 forms a ball joint bearing for the other ball joint 212, having a complimentary shape to the other ball joint 212. The anti-twist assembly can ensure a twist-free movement of the section of the shift lever 200 received in the receiver 112 in relation to the sliding element 110 when the shift lever 200 is actuated. The engagement of the securing pin 214 in the opening 114 prevents a twisting of the sliding element 110 about the longitudinal extension axis of the shift lever 200 thereby. Furthermore, the securing pin 214 can rotate about its longitudinal extension axis in the anti-twist element 114. Furthermore, the securing pin 214 can move in the anti-twist element 114 formed as a passage, along a passage plane in which the passage is located. As a result, a possible twisting in various directions of the sliding element 110 can be counteracted. In this manner, a guided movement of the sliding element 110 can be ensured, without twisting.

According to an exemplary embodiment that is not shown, as an alternative to the design as a passage described above, the opening or cavity 114 can form a shaft having a shaft floor that lies opposite the opening to the shaft for receiving the securing pin 214. A spacing between the opening plane, in which the shaft opening is disposed, and the shaft floor, defines a shaft depth thereby, which can be adapted to the intended use. The shaft depth is selected thereby, such that the securing pin 214 can move in the shaft 114 along a plane intersecting the shaft opening and the shaft floor. As a result, a movement of the sliding element 110 can likewise be ensured, accordingly without twisting.

The latching pin 206 of the illustrated preferred exemplary embodiment is received in a hole, which is formed on the end surface of the further end 204, and extends parallel to the longitudinal extension axis of the shift lever. The latching pin protrudes with a spherical head 207 out of the hole. The latching pin 206 is supported in the hole in a resilient manner by means of a compression spring 205 disposed between the spherical head 207 and a hole end lying opposite the spherical head. As a result, the latching pin 206 can slide in a spring-loaded manner along a predetermined latching contour that has been formed. The latching pin 206 and the hole can have a typical design, such as that described by way of example in DE 103 44 287.

FIG. 5 shows a sectional view of the coupling device 100 with the shift lever 200 shown in FIG. 3, along the cut V-V. In the position shown in this Figure, the shift lever 200 as well as the sliding element 110 are in a middle position, as described above. The sliding element 110 is disposed in relation to the guide 120 such that the free ends 113 of the sliding element 110 each exhibit a predetermined spacing to the base of the respective dedicated U-shaped groove 124. The sliding element 110, and thus the shift lever 200, can move freely along the first movement axis in opposing directions.

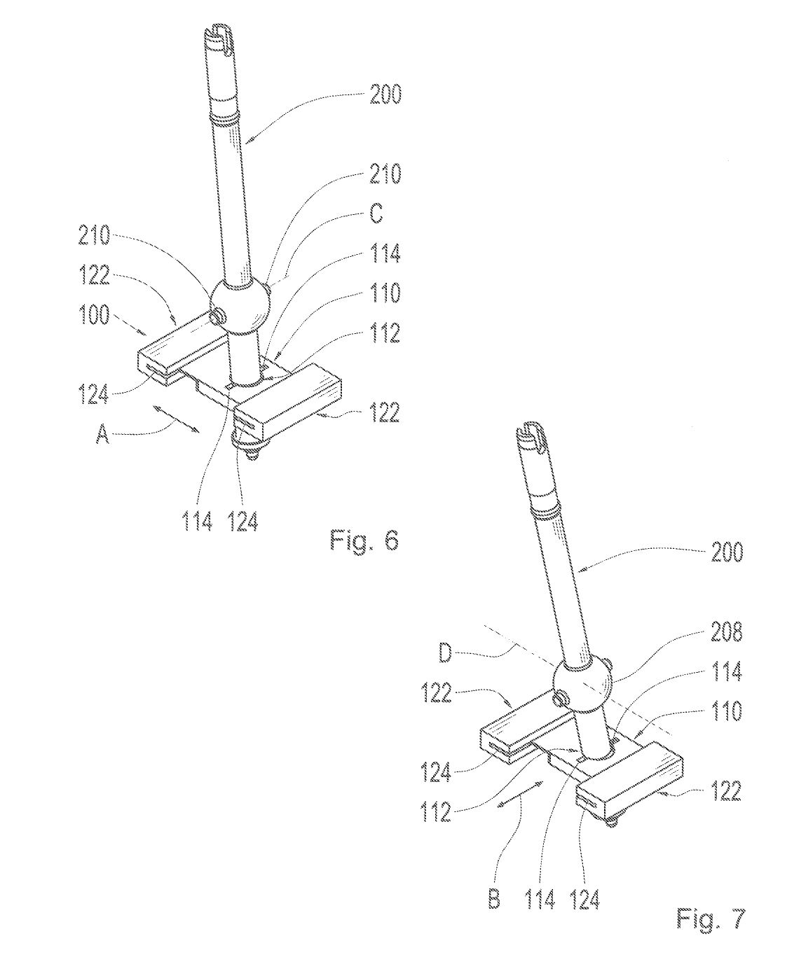

FIG. 6 shows the coupling device 100 with the shift lever 200 shown in FIG. 1, in a first deflected position along the first movement axis A of the sliding element 110. The shift lever 200 is swiveled or rotated thereby about a rotational axis C formed by the ball joint pin 210 in a predetermined manner. By means of the engagement with the section of the shift lever accommodated in the receiver 112, the sliding element 110 is forced to move along the first movement axis A. The first movement axis A runs perpendicular to the longitudinal extension direction of the groove 124 of the guide 120 receiving the respective free ends 113 of the sliding element 110. The securing pins 214 received in the hole 114 function likewise as rotation pins thereby, which form a further axis of rotation, about which the section of the shift lever 200 accommodated in the receiver 112 moves in relation to the sliding element 110. As a result, a twisting of the sliding element 110 in the guide 120 in a rotational direction about the rotational axis of the securing pin 214 is counteracted. The ball joint-like design of the section of the shift lever 200 accommodated in the receiver 112 reinforces a prevention of the twisting of the sliding element 110 in relation to the guide 120 about the rotational axis formed by the securing pin 214.

FIG. 7 shows the coupling device 100 with the shift lever 200 shown in FIG. 1, in a second deflected position along the second movement axis B. The second movement axis B runs orthogonally to the first movement axis A shown in FIG. 7, wherein the second movement axis B extends parallel to a longitudinal extension axis of the respective grooves 124 of the guide 120. The shift lever 200 is swiveled thereby about a second rotational axis D, wherein the second rotational axis D is orthogonal to the first rotational axis C, and extends through the midpoint of the ball joint 208. Such a rotational movement can be implemented, for example, by means of a Cardanic bearing. The movement of the shift lever 200 about the second rotational axis D causes a sliding of the sliding element 110 along the respective grooves 124 of the respective guide elements 122, or along the second movement axis B, respectively. The design of the receiver 112 with the openings 114, which are engaged with the securing pin 214 and the ball joint-like section of the shift lever 200, described above, facilitates thereby a prevention of a twisting of the sliding element 110 in the respective grooves 124 in relation to the guide 120.

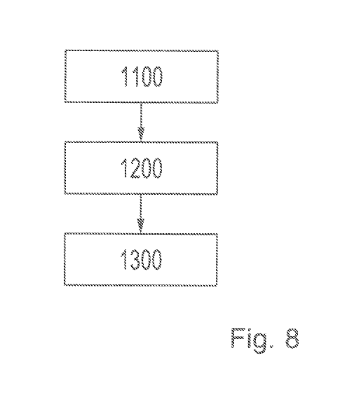

FIG. 8 shows a flow chart for a method for producing a coupling device, in particular a coupling device according to one of the preferred exemplary embodiments described above. The method comprises a step 1100 for the provision of a sliding element, a step 1200 for the provision of a guide, and a step 1300 for bringing the sliding element into engagement with the guide. The provision steps need not necessarily be executed in the sequence described above. The step for providing the sliding element can also take place after the step for providing the guide, or simultaneously with the step for providing the guide. According to a preferred exemplary embodiment, the guide can be formed with a housing for the shift lever device, which accommodates the shift lever, or it can be provided with the housing. The housing can have a two-piece design thereby, wherein each housing part has one of the guide elements described above. The step for providing the guide can define a step for providing a housing part of a shift lever device thereby, wherein the step for bringing the sliding element into engagement with the guide corresponds to a step for inserting one of the free ends of the sliding element into the groove of the guide element. The step for bringing the components into engagement can furthermore comprise a step for mounting the second housing part that has one of the guide elements 122, to the first housing part that has the other guide element, wherein the other free end 113 of the sliding element is inserted into the groove of the guide element in the second housing part.

Exemplary embodiments of the present invention, variations, and further aspects shall be summarized below, and explained in an alternative manner, with reference to FIGS. 1-7.

According to one exemplary embodiment, the coupling device 100 can be provided for forming a latching mechanism for the shift lever. With this preferred exemplary embodiment, at least one engaged free end of the sliding element can form a latching contour with a dedicated guide element, which has at least one latching peak and numerous latching troughs that can be brought into engagement with the at least one latching peak, or a least one latching trough, and numerous latching peaks that can be brought into engagement with the at least one latching trough, wherein a latching peak and a latching trough are engaged in each of the possible positions of the shift lever along the respective movement axes. The latching peak preferably forms a complimentary shape to the latching trough thereby. As a result, a structurally simple design for a latching device for the shift lever of a shift lever device can be created. Furthermore, the other free end of the shift lever can be accommodated by the receiver of the sliding element. In this manner, the shift lever device can have a compact design along a longitudinal extension of the shift lever supported in the shift lever device.

According to one exemplary embodiment, the sliding element 110 can have a connection for a force transference element, which is coupled to, or can be coupled to, a parking lock of a gear changing transmission. By moving the sliding element along one of the movement axes, the force transference element can be forced to move, such that the parking lock of the gear changing transmission can be engaged and/or disengaged. By way of example, this can take place in the framework of an emergency release mechanism, in which the parking brake is intended to be able to be mechanically disengaged.

According to one exemplary embodiment, the sliding element can have at least one signal issuing element, which can be brought into a functional relationship with at least one signal receiving element, depending on a position of the sliding element. The signal issuing element can be a magnet, for example, and the signal receiving element can be a magnet-sensitive element, wherein the magnet-sensitive element receives a signal and indicates whether a magnetic field of the magnet element has acted on the magnet-sensitive element. In this manner, a position detection device for the shift lever of a shift lever device can be provided by means of the coupling device. Positioning of the at least one signal issuing element and the at least one signal receiving element is preferably to be selected such that the signal receiving element then issues a position detection signal when the shift lever has assumed a predefined position and/or is going to assume the predefined position.

The exemplary embodiments described herein and shown in the Figures are selected only by way of example. Different exemplary embodiments can be combined with one another, either in their entirety or with respect to individual features. Moreover, one exemplary embodiment can be supplemented with features of another exemplary embodiment.

Furthermore, method steps may be repeated, as well as executed in a different sequence that that described herein.

If an exemplary embodiment comprises an “and/or” conjunction between a first feature and a second feature, this can be read to mean that the exemplary embodiment according to one embodiment includes both the first feature as well as the second feature, and according to another embodiment, includes either just the first feature or just the second feature.

### REFERENCE SYMBOLS

100 coupling device
110 sliding element
111 thick element
112 receiver
113 free end
114 anti-twist element
120 guide
122 guide element
124 groove
200 shift lever
202 free end
204 other free end
205 compression spring
206 latching pin
207 spherical head
208 ball joint
210 ball joint pin
212 further ball joint
214 securing pin
1100 provision step
1200 provision step
1300 engagement step
A first movement axis
B second movement axis
C first rotational axis
D second rotational axis

1. A coupling device for a shift lever of a motor vehicle shift lever device, the coupling device comprising:
a moving sliding element having a receiver for accommodating a section of the shift lever; and
a guide for guiding a two-dimensional movement of the sliding element, wherein the guide has at least one guide element, with which the sliding element is engaged, the sliding element movable along two different movement axes (A, B) to the at least one guide element when the sliding element is engaged.

2. The coupling device according to claim 1, wherein the two different movement axes (A, B) define a planar movement plane for movements of the sliding element.

3. The coupling device according to claim 1, wherein the two different movement axes (A, B) are orthogonal to one another.

4. The coupling device according to claim 1, wherein the at least one guide element forms either a groove or a tongue of a tongue-and-groove connection, and the sliding element forms the other of either the tongue or the groove of the tongue-and-groove connection.

5. The coupling device according to claim 1, wherein the at least one guide element comprising a first guide element and a second guide element with which the sliding element is engaged, and wherein the first guide element and the second guide element are disposed opposite one another, with the sliding element positioned therebetween.

6. The coupling device according to claim 5, wherein the first guide element and the second guide element each have a stop, which lie opposite one another along the two different movement axes (A, B) to limit a movement of the sliding element.

7. The coupling device according to claim 1, wherein the receiver has an anti-twist element for engaging with an anti-twist counter-element of the shift lever.

8. The coupling device according to claim 7, wherein the anti-twist element is formed by a passage which extends parallel to the receiver passing through the sliding element.

9. A shift lever device for a motor vehicle, comprising:
a shift lever that is supported such that the shift lever is movable at least two-dimensionally, and a coupling device according to claim 1, wherein a free section of the shift lever is accommodated in the receiver of the sliding element, and wherein the receiver is configured to transfer a movement force directed along a respective movement axes (A, B) between the shift lever and the sliding element.

10. The shift lever device according to claim 9, wherein the shift lever device comprises a housing, which forms the guide.

11. The shift lever device according to claim 9, wherein the shift lever includes an anti-twist counter-element engaged with an anti-twist element of the sliding element, and wherein the anti-twist counter-element and the anti-twist element are formed by a pin and a pin receiver that accommodates the at least one pin to prevent at least a twisting movement of the sliding element about the shift lever.

12. The shift lever device according to claim 11, wherein the pin receiver in the sliding element forms a shaft extending in a receiving direction of the pin, which forms a passage through the sliding element, or which has a shaft floor which is spaced apart from the pin in each of a plurality of positions of the shift lever that triggers a predefined function.

13. The shift lever device according to claim 8, wherein the sliding element has at least one signal issuing element of a position detection device for determining a shift lever position, a latching contour of a latching mechanism for latching the shift lever, or a connection for a force transference element of a parking lock device for engaging and disengaging a parking lock of a motor vehicle transmission.

14. A method for producing a coupling device, the method comprising:
providing a sliding element;
providing a guide having a guide element; and
bringing the sliding element into engagement with the guide.

15. The method according to claim 14, wherein bringing the sliding element into engagement with the guide comprises inserting a free end of the sliding element into a groove of the guide element.

16. The method according to claim 15, wherein the guide includes an additional guide element, and wherein bringing the sliding element into engagement with the guide further comprises inserting an opposing free end of the sliding element into a groove of the additional guide element.

17. The method according to claim 14, wherein the sliding element includes a receiver formed through a thickness of the sliding element, the method further comprising extending a shift lever through the receiver to accommodate a latching pin.

18. The coupling device according to claim 1, wherein the sliding element is movable along a movement axis A extending a length of a groove formed in the at least one guide element and movable along a movement axis B orthogonal to the movement axis A, the movement axis B extending along a depth of the groove.

19. The coupling device according to claim 18, wherein the movement axis A and the movement axis B define a planar movement plane for movements of the sliding element.

20. The coupling device according to claim 1, wherein the receiver includes a first opening extending from a surface of the sliding element into the sliding element to a depth, the first opening configured to accept a securing pin of a shift lever positioned in the receiver.
